(19) United States
(12) Patent Application Publication
(10) Pub. No.: US 2026/0312413 A1
(43) Pub. Date: Oct. 8, 2026

(54) DATA CENTER POWERED BY A RENEWABLE ENERGY SOURCE

(71) Applicant: Sage Geosystems Inc., Houston, TX (US)

(72) Inventors: Robert Lance COOK, Houston, TX (US); Cynthia D. TAFF, Kingwood, TX (US); Lev M. RING, Bellaire, TX (US)

(21) Appl. No.: 19/483,173

(22) PCT Filed: May 23, 2024
(86) PCT No.: PCT/US2024/030794

§ 371 Date: Nov. 10, 2025

Related U.S. Application Data
(63) Continuation-in-part of application No. PCT/US2024/030535, filed on May 22, 2024.
(60) Provisional application No. 63/504,640, filed on May 26, 2023.
(60) Provisional application No. 63/504,640, filed on May 26, 2023.

(51) Int. Cl. H02J 3/38; G06N 20/00; H02J 7/34; H02J 7/50; H02J 101/24; H02J 101/28; H02J 105/12

(52) U.S. Cl. CPC H02J 3/38; G06N 20/00; H02J 7/342; H02J 7/575; H02J 2101/24; H02J 2101/28; H02J 2105/12

(57) ABSTRACT

A power plant generates direct current electrical power. A data center receives the direct current electrical power from the power plant. At least a portion of the direct current electrical power is used to charge a battery which provides power to one or more racks of a computer system at the data center. The data center may also include a controller configured to implement a plurality of computer executable instructions that, when implemented by the controller, cause the data center to operate using the received direct current electrical power.

### CROSS-REFERENCE TO RELATED APPLICATIONS

This application is an International Patent Application under the Patent Cooperation Treaty and claims priority to and the benefit of: U.S. Provisional Patent Application Ser. No. 63/504,640 filed May 26, 2023, titled Geothermal Powered Charging Station; and International Patent Cooperation Treaty Application PCT/US2024/030535 filed May 22, 2024 and titled Charging Station Powered by a Renewable Energy Source. The disclosures of each of U.S. Provisional Patent Application Ser. No. 63/504,640 and International Patent Cooperation Treaty Application PCT/US2024/030535 are incorporated herein in their entireties by this reference.

### BACKGROUND

### Field

Embodiments of the present disclosure generally relate to the provision of electrical power to computer data centers that perform (for example) rapid, complex computing operations that are computing processing power-intensive, such as cryptocurrency mining or the training or use of artificial intelligence programs.

### Description of the Related Art

The continued growth in demand for computing power is exemplified by the increasing usage of computers for such operations as cryptocurrency mining, and the training and use of artificial intelligence programs. Such operations create demands for greater numbers of processors, greater computing power (such as the number of operations per second) of those processors, and enhanced computer memory capacity.

Such demands for ever-increasing computing capabilities may be met by establishing data centers containing many interlinked computers. The number of data centers around the world has been rapidly increasing, and is expected to continue rising. However, the larger numbers of data centers, each containing greater quantities of higher powered processors, present an ever-increasing need for electrical power. It has been estimated, such as by the International Energy Agency in January 2024, that global electricity demands of data centers could rise to over 1000 TWh (equivalent to the entire electricity demand of a single country such as Germany) by 2026.

Such a rapid increase electricity demand will place ever-increasing burdens on existing electrical power generation capacity and on existing electrical power distribution grids. The construction of such infrastructure is expensive and time consuming.

There is a need for improved systems and processes that facilitate the provision of electrical power to the increasing number of data centers without overloading existing electrical power infrastructure.

### SUMMARY

The present disclosure generally relates to the provision of electrical power to computer data centers that perform (for example) rapid, complex computing operations that are computing processing power-intensive, such as cryptocurrency mining or the training or use of artificial intelligence programs. In one implementation, a system includes a power plant configured to produce direct current electrical power. The system further includes a data center electrically coupled to the power plant, and configured to receive the direct current electrical power and convey a first portion of the direct current electrical power to a first battery of a rack of a computer system of the data center.

In another implementation, a system includes a power plant configured to produce direct current electrical power, a data center electrically coupled to the power plant, and a controller comprising instructions that, when executed, cause a plurality of operations to be conducted. The plurality of operations include receiving, at the data center, direct current electrical power from the power plant, charging a first battery at the data center using at least a first portion of the direct current electrical power, and providing power from the first battery to a rack of a computer system of the data center.

In another implementation, a method of operating a data center includes receiving, at the data center, direct current electrical power from a power plant, charging a first battery at the data center using at least a first portion of the direct current electrical power, and providing power from the first battery to a rack of a computer system of the data center.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 schematically illustrates a geothermal power plant.

FIG. 2 schematically illustrates a data center.

FIG. 3 schematically illustrates a local power distribution system.

FIG. 4 is a flow diagram of a method of operating a data center.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns the provision of electrical power to computer data centers. In some aspects, the data centers perform rapid, complex computing operations that are computing processing power-intensive. Exemplary computing operations include cryptocurrency mining and the training or use of artificial intelligence programs.

In some aspects, features of the present disclosure facilitate the siting of data centers in locations where there is no (or limited) existing electrical transportation infrastructure or capacity, such as in remote and/or rural areas.

Recent improvements in geothermal power systems allow their use not only in areas that are recognized sources of geothermal power, but also in areas previously thought to be unsuitable for producing electricity by geothermal systems. In addition, co-locating a data center with a power system, such as a solar, solar thermal, wind-driven, or geothermal power system, could reduce or even eliminate the costs (infrastructure, transmission losses, etc.) involved with transmitting electricity over distances of several kilometers (such as tens of kilometers) compared with the provision of a conventional electrical power grid.

Co-locating a data center with a power system, such as a solar, solar thermal, wind-driven, or geothermal power system, facilitates the generation of direct current (DC) electrical power by the power system and transmitting the DC power to the data center. Computer processors work from DC electrical power. Although computers are typically plugged into an alternating current (AC) power supply, the AC power must be converted to DC power for the computers to function. The generation and transmission of DC power local to a data center may reduce or eliminate the infrastructure and costs associated with the generation and transmission of AC electrical power and the conversion of the AC electrical power to DC electrical power.

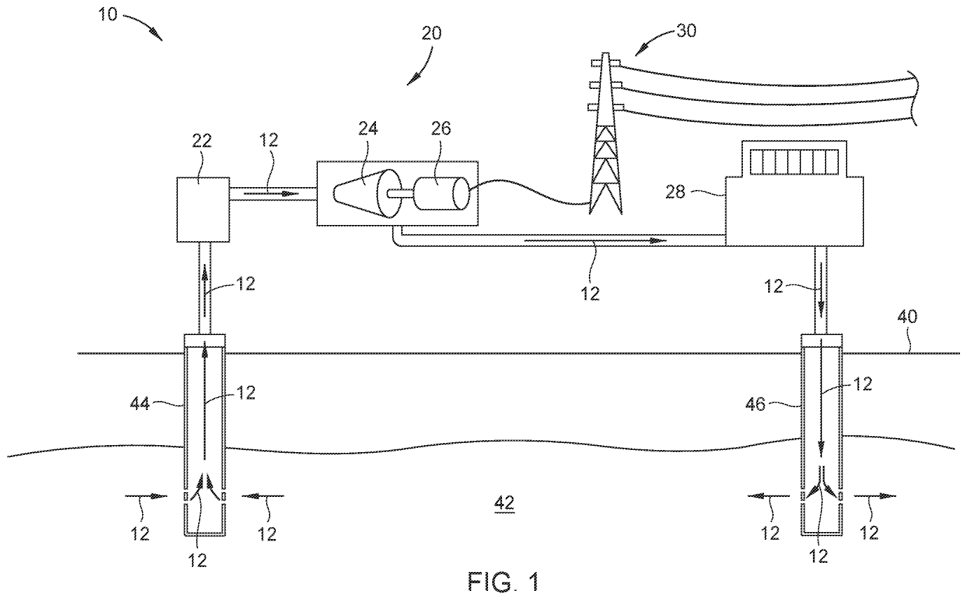

FIG. 1 schematically illustrates a geothermal power plant 10. The geothermal power plant 10 includes a power generation unit 20 located at the Earth's surface 40. The power generation unit 20 may be of any suitable type that converts heat energy and/or pressure energy to electricity, and may include any one or more of an expansion unit 22, a turbine 24, a generator 26, or a cooling unit 28. Some examples of representative power generation units 20 include a direct dry steam plant, a flash plant, a binary plant, a combined-cycle or hybrid plant, etc., that receives heated fluid from surface or subsurface sources of heat. In an example, the turbine 24 drives the generator 26 to produce electricity. In some embodiments, the generator 26 produces direct current (DC) electrical power. In some embodiments, the generator 26 produces alternating current (AC) electrical power.

The geothermal power plant 10 utilizes a working fluid (represented by arrows 12), such as water, steam, brine, a refrigerant, a supercritical fluid, carbon dioxide, ammonia, an organic compound (e.g., a hydrocarbon, a fluorocarbon, etc.), or any combination thereof. In some embodiments, the working fluid 12 is heated, or is maintained at an elevated temperature, in a subterranean formation 42. In an example, the temperature of the working fluid 12 is at or about 150 degrees C or higher, such as 175 degrees C or higher, 200 degrees C or higher, 250 degrees C or higher, or 300 degrees C or higher.

In some embodiments, the working fluid 12 is maintained at an elevated pressure in the subterranean formation 42. In an example, the pressure of the working fluid 12 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the working fluid 12 is geopressured. In an example, the working fluid 12 may be a geopressured-geothermal fluid.

The working fluid 12 flows from the subterranean formation 42 to surface 40 via a first well 44. The first well 44 is a geothermal well. The working fluid 12 is utilized by the geothermal power plant 10 to produce electricity. In some embodiments, the working fluid 12 powers the turbine 24 which drives the generator 26. In some embodiments, the power generation unit 20 transfers heat energy and/or pressure energy of the working fluid 12 to a second fluid, and the second fluid powers the turbine 24 which drives the generator 26. In some embodiments, the generator 26 produces AC electrical power. In some embodiments, the generator 26 produces DC electrical power. The generated electricity is routed to an electricity distribution system 30, such as a power grid. In the illustrated example, the working fluid 12 is returned to the subterranean formation 42 via a second well 46. In some embodiments, the working fluid 12 is returned to the subterranean formation 42 via the first well 44.

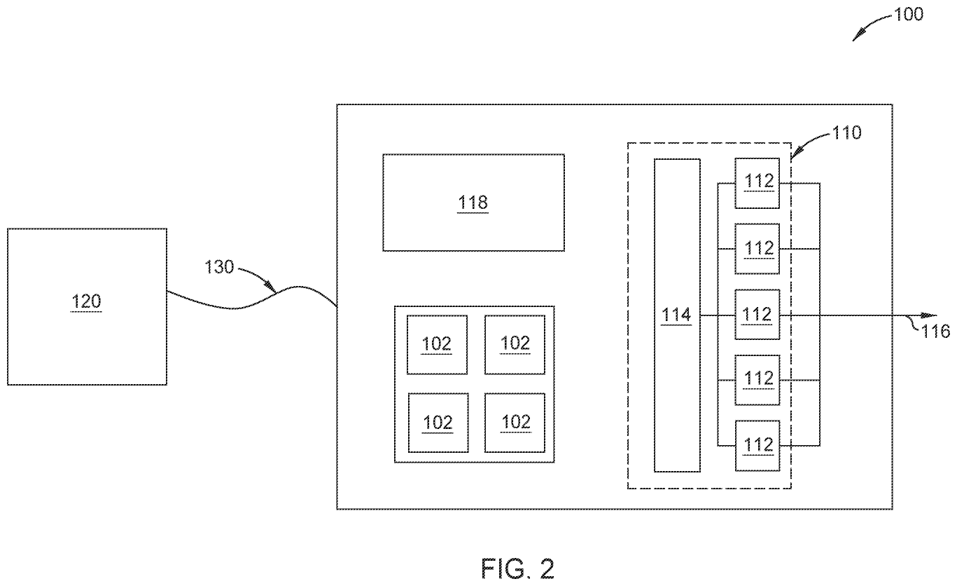

FIG. 2 schematically illustrates a data center 100. In some embodiments, the data center 100 includes one or more computer systems 110 that include one or more racks 112. As shown, each rack 112 may be coupled to one or more corresponding local batteries 114, such as via one or more power distribution units. Each rack 112 includes modules that perform functions of a server, data storage, and core networking (such as firewalls, switches, rack controllers, WIFI, and routers).

Each rack 112 may use the WIFI or routers to perform data import and export 116. In some embodiments, the data export 116 is performed via a metallic cable. In some embodiments, the data export 116 is performed via an optical fiber cable. In some embodiments, the data export 116 is performed via satellite communication. In some embodiments, the data export 116 is performed via microwave communication.

In some embodiments, the one or more computer systems 110 use AC power only. In some embodiments, the one or more computer systems 110 use DC power only. In some embodiments, the one or more computer systems 110 use AC power and DC power.

In some embodiments, the data center 100 includes equipment 118 that uses AC power. In an example, the equipment 118 includes lighting, one or more refrigerators or freezers, communication equipment (such as internet, cable, satellite, or telephone equipment), or other AC electrical items, such as AC electrical items that are typically used in personnel break rooms.

The data center 100 receives electrical power from a power plant 120. In some embodiments, the data center 100 includes one or more main batteries 102 that store DC power for use at the data center 100. The one or more main batteries 102 are charged by the electricity received from the power plant 120. As described below, the one or more main batteries 102 supply electrical power to the one or more computer systems 110 or the equipment 118 that uses AC power.

In some embodiments, the power plant 120 includes a solar power plant. In some embodiments, the power plant 120 includes a solar thermal power plant. In some embodiments, the power plant 120 includes a wind-driven power plant. In some embodiments, the power plant 120 includes a geothermal power plant, such as geothermal power plant 10.

In some embodiments, the power plant 120 includes a first power plant and a second power plant. The first power plant is one of a solar power plant, a solar thermal power plant, a wind-driven power plant, or a geothermal power plant (such as geothermal power plant 10). The second power plant is a different one of a solar power plant, a solar thermal power plant, a wind-driven power plant, or a geothermal power plant (such as geothermal power plant 10). In an example, the power plant 120 includes a solar power plant and a geothermal power plant (such as geothermal power plant 10). In another example, the power plant 120 includes a solar thermal power plant and a geothermal power plant (such as geothermal power plant 10). In a further example, the power plant 120 includes a wind-driven power plant and a geothermal power plant (such as geothermal power plant 10).

In some embodiments, the power plant 120 generates AC electrical power only. In some embodiments, the power plant 120 generates DC electrical power only. In some embodiments, the power plant 120 generates AC electrical power and DC electrical power. In an example, at least one generator (such as generator 26) generates AC electrical power, and at least one generator (such as another generator 26) generates DC electrical power.

The electricity generated by the power plant 120 is transmitted to the data center 100 by a local power distribution system 130, such as the electricity distribution system 30. In some embodiments, the local power distribution system 130 transmits AC power only to the data center 100. In some embodiments, the local power distribution system 130 transmits DC power only to the data center 100. In some embodiments, the local power distribution system 130 transmits AC power and DC power to the data center 100.

In some embodiments, at least a portion of the power plant 120 (such as first well 44 of geothermal power plant 10) is co-located with the data center 100. In an example, at least a portion of the power plant 120 is located close to the data center 100, such as up to 5 km, up to 4 km, up to 3 km, up to 2 km, or up to 1 km from the data center 100. In another example, at least a portion of the power plant 120 is located at a distance from the data center 100 such that the efficiencies of transmitting a direct current from the power plant 120 to the data center 100 are greater than the efficiencies of converting the direct current to alternating current at the power plant 120, and then converting the alternating current back to direct current at the data center 100. In another example, at least a portion of the power plant 120 is located at a distance from the data center 100 such that the portion of the power plant 120 is located within a square mile (2.6 sq. km) of the data center 100, such as within a half square mile (1.3 sq. km), within a quarter square mile (0.65 sq. km), within a tenth of a square mile (0.26 sq. km), within a hundredth of a square mile (0.026 sq. km), or within a thousandth of a square mile (0.0026 sq. km) of the data center 100.

In some embodiments, the local power distribution system 130 is electrically coupled to a national or regional power distribution system. In some embodiments, the local power distribution system 130 is an autonomous power distribution system that is not electrically coupled with a national or regional power distribution system. In some embodiments, the data center 100 is electrically coupled to a national or regional power distribution system in addition to being electrically coupled to the local power distribution system 130. In some embodiments, the data center 100 is not electrically coupled to a national or regional power distribution system, but is electrically coupled to the local power distribution system 130.

In some embodiments, the data center 100 receives at least a portion of the electrical power used on site via a national or regional power distribution system. In some embodiments, the data center 100 does not receive any electrical power via a national or regional power distribution system. In some embodiments, the data center 100 receives at least 50% (such as at least 60%, at least 70%, at least 80%, or at least 90%) of the electrical power used on site via the local power distribution system 130. In some embodiments, the data center 100 receives 100% of the electrical power used on site via the local power distribution system 130.

In some embodiments, the data center 100 receives at least a portion of the electrical power used on site from the power plant 120. In some embodiments, the data center 100 receives at least 50% (such as at least 60%, at least 70%, at least 80%, or at least 90%) of the electrical power used on site from the power plant 120. In some embodiments, the data center 100 receives 100% of the electrical power used on site from the power plant 120.

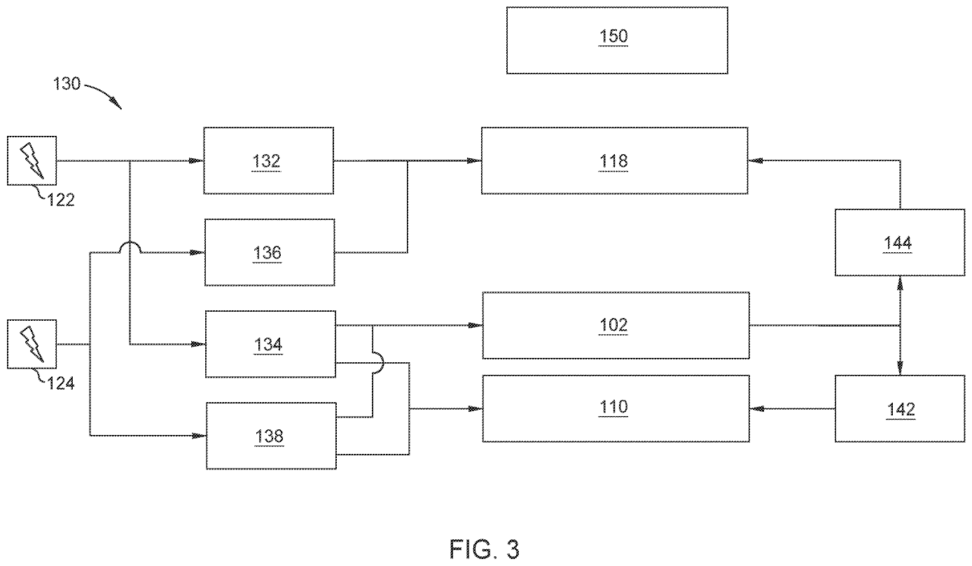

FIG. 3 schematically illustrates the local power distribution system 130 in further detail. The local power distribution system 130 is illustrated to represent embodiments in which the local power distribution system 130 receives AC power from an AC power supply 122 (such as the power plant 120 or a national or regional power distribution system). The local power distribution system 130 is illustrated also to represent embodiments in which the local power distribution system 130 receives DC power from a DC power supply 124 (such as the power plant 120 or a national or regional power distribution system).

In some embodiments, the local power distribution system 130 is electrically coupled to the AC power supply 122 but not to the DC power supply 124. In some embodiments, the DC power supply 124 is omitted. In some embodiments, the local power distribution system 130 is electrically coupled to the DC power supply 124 but not to the AC power supply 122. In some embodiments, the AC power supply 122 is omitted. In some embodiments, the local power distribution system 130 is electrically coupled to the AC power supply 122 and to the DC power supply 124.

In some embodiments, at least a portion of the local power distribution system 130 is operated as a DC microgrid. In some embodiments, such as embodiments in which the AC power supply 122 is omitted, the entire local power distribution system 130 is operated as a DC microgrid. A DC microgrid has several advantages over an AC power distribution system. DC microgrids can be integrated easily with the power plant 120 in embodiments in which the power plant 120 includes one or more renewable energy sources, such as solar, solar thermal, wind, or geothermal energy sources. The DC microgrid may include fewer or smaller stages of power conversion compared to an AC power distribution system. A DC system has no skin effect resulting from induced changing currents in a conductor core. The lack of skin effect reduces losses to power transmission, and permits the use of fewer conductors. Some features of an AC power distribution system, such as grid synchronization, harmonics compensation, and reactive power control, typically are not required for DC-based systems. A DC microgrid provides continuous power supply to an electrical load during power outages and grid disturbances by using electrical storage systems (e.g. battery backups), such as the main batteries 102. A DC microgrid typically requires only one component/factor to control, i.e., DC power.

In some embodiments in which the local power distribution system 130 receives AC power from the AC power supply 122, at least a portion of the AC power is routed via one or more transformers 130 to the equipment 118 that uses AC power. At least a portion of the AC power is routed to one or more AC-to-DC converters 134. The one or more AC-to-DC converters 134 convert the AC power to DC power. The one or more AC-to-DC converters 134 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, the DC power produced by the one or more AC-to-DC converters 134 is routed to the main batteries 102 for charging the main batteries 102. In some embodiments, the DC power produced by the one or more AC-to-DC converters 134 is routed to the one or more computer systems 110 for charging the one or more local batteries 114.

In some embodiments, the one or more AC-to-DC converters 134 include a first AC-to-DC converter 134 configured to produce DC power at a first voltage, and a second AC-to-DC converter 134 configured to produce DC power at a second voltage that is different from the first voltage. In an example, the first voltage may be suitable for charging the main batteries 102 (such as 12V, 24 V, or 48 V), and the second voltage may be suitable for charging the one or more local batteries 114 (such as 50 V or 60 V). In some embodiments, the DC power from the one or more AC-to-DC converters 134 is routed to a DC-to-DC converter to produce DC power at an appropriate voltage prior to routing the DC power to the main batteries 102 or the one or more computer systems 110.

In some embodiments in which the local power distribution system 130 receives DC power from the DC power supply 124, at least a portion of the DC power is routed via one or more DC-to-AC inverters 136 to the equipment 118 that uses AC power. The one or more DC-to-AC inverters 136 convert the DC power to AC power. The one or more DC-to-AC inverters 136 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, at least a portion of the DC power is routed via one or more DC-to-DC converters 138 to the main batteries 102 for charging the main batteries 102. In some embodiments, at least a portion of the DC power is routed via the one or more DC-to-DC converters 138 to the one or more computer systems 110 for charging the one or more local batteries 114.

The one or more DC-to-DC converters 138 facilitate smoothing of the current and voltage received from the DC power supply 124, and output DC power at appropriate voltage and current for use. The one or more DC-to-DC converters 138 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, the one or more DC-to-DC converters 138 include a first DC-to-DC converter 138 configured to produce DC power at a first voltage, and a second DC-to-DC converter 138 configured to produce DC power at a second voltage that is different from the first voltage. In an example, the first voltage may be suitable for charging the main batteries 102 (such as 12V, 24 V, or 48 V), and the second voltage may be suitable for charging the one or more local batteries 114 (such as 50 V or 60 V).

In some embodiments, at least a portion of the DC power is routed to the main batteries 102 without being transmitted via the one or more DC-to-DC converters 138. In some embodiments, at least a portion of the DC power is routed to the one or more computer systems 110 without being transmitted via the one or more DC-to-DC converters 138. In some embodiments, the one or more DC-to-DC converters 138 may be bypassed or omitted.

In some embodiments, the main batteries 102 provide back-up power to the data center 100. In an example, the main batteries 102 provide back-up power to the one or more computer systems 110. DC power provided by the main batteries 102 is routed via one or more DC-to-DC converters 142 to the one or more computer systems 110. In some embodiments, DC power provided by the main batteries 102 is routed via the one or more DC-to-DC converters 142 to the one or more local batteries 114. The one or more DC-to-DC converters 142 may be electrical and/or electro-mechanical, and may include any one or more of semiconductors, power semiconductors, integrated circuits. vibrators, transformers, inductors, magnetic field storage components, capacitors, field-effect transformers, transistors, diodes, or other such systems or components, in any combination. In some embodiments, the one or more DC-to-DC converters 142 may be bypassed or omitted.

In some embodiments, the main batteries 102 provide back-up power to the equipment 118 that uses AC power. DC power provided by the main batteries 102 is routed via one or more DC-to-AC inverters 144 to the equipment 118 that uses AC power. The one or more DC-to-AC inverters 144 convert the DC power from the main batteries 102 into AC power for the equipment 118. The one or more DC-to-AC inverters 144 may be electrical and/or electro-mechanical, and may include any one or more of semiconductors, power semiconductors, integrated circuits, vibrators, transformers, inductors, magnetic field storage components, capacitors, field-effect transformers, transistors, diodes, or other such systems or components, in any combination.

In some embodiments, operation of the data center 100 or the local power distribution system 130 is controlled at least in part by a controller 150. The controller 150 includes a central processing unit (CPU), a memory containing instructions, and support circuits for the CPU. The memory, or non-transitory computer readable medium, is one or more of a readily available memory such as random access memory (RAM), read only memory (ROM), floppy disk, hard disk, flash drive, solid state drive, or any other form of digital storage, local or remote. The support circuits are coupled to the CPU for supporting the CPU. The support circuits include cache, power supplies, clock circuits, input/output circuitry and subsystems, and the like. Operations and operating parameters are stored in the memory as a software routine that is executed or invoked to configure the controller 150 into a specific purpose controller to control the operations of the data center 100 or the local power distribution system 130. The controller 150 is configured to conduct one or more of the operations described herein. The instructions stored on the memory, when executed, cause one or more of the operations described herein to be conducted.

In some embodiments, the controller 150 is communicatively coupled to the one or more computer systems 110. In some of such embodiments, the controller 150 is communicatively coupled to each rack 112 of the one or more computer systems 110. In an example, the controller 150 is communicatively coupled to each rack 112 via each rack controller. In some embodiments, the controller 150 is communicatively coupled to each local battery 114. In some embodiments, the controller 150 is communicatively coupled to each power distribution unit. The controller 150 monitors and controls the functioning of the one or more computer systems 110.

In some embodiments, the controller 150 is communicatively coupled to each main battery 102. In an example, the controller 150 is communicatively coupled to one or more sensors of each main battery 102. The controller 150 monitors and controls the functioning of each main battery 102.

In some embodiments, the controller 150 is communicatively coupled to one or more items of the equipment 118 that use AC power. In an example, the controller 150 is communicatively coupled to one or more sensors of the one or more items of the equipment 118. The controller 150 monitors and controls the functioning of the one or more items of the equipment 118.

In some embodiments, the controller 150 is communicatively coupled to the local power distribution system 130. In an example, the controller 150 is communicatively coupled to one or more sensors of the local power distribution system 130. The controller 150 monitors and controls the functioning of the one or more items of the local power distribution system 130.

In some embodiments, the controller 150 is communicatively coupled to the one or more transformers 132. In an example, the controller 150 is communicatively coupled to one or more sensors of the one or more transformers 132. The controller 150 monitors and controls the functioning of the one or more transformers 132.

In some embodiments, the controller 150 is communicatively coupled to the one or more AC-DC converters 134. In an example, the controller 150 is communicatively coupled to one or more sensors of the one or more AC-DC converters 134. The controller 150 monitors and controls the functioning of the one or more AC-DC converters 134.

In some embodiments, the controller 150 is communicatively coupled to the one or more DC-AC inverters 136. In an example, the controller 150 is communicatively coupled to one or more sensors of the one or more DC-AC inverters 136. The controller 150 monitors and controls the functioning of the one or more DC-AC inverters 136.

In some embodiments, the controller 150 is communicatively coupled to the one or more DC-DC converters 138. In an example, the controller 150 is communicatively coupled to one or more sensors of the one or more DC-DC converters 138. The controller 150 monitors and controls the functioning of the one or more DC-DC converters 138.

In some embodiments, the controller 150 is communicatively coupled to the one or more DC-DC converters 142. In an example, the controller 150 is communicatively coupled to one or more sensors of the one or more DC-DC converters 142. The controller 150 monitors and controls the functioning of the one or more DC-DC converters 142.

In some embodiments, the controller 150 is communicatively coupled to the one or more DC-AC inverters 144. In an example, the controller 150 is communicatively coupled to one or more sensors of the one or more DC-AC inverters 144. The controller 150 monitors and controls the functioning of the one or more DC-AC inverters 144.

In some embodiments, the controller 150 is communicatively coupled to the power plant 120. In an example, the controller 150 is communicatively coupled to one or more sensors of the power plant 120. The controller 150 monitors and controls the functioning of the power plant 120.

In some embodiments, the controller 150 is communicatively coupled to the AC power supply 122. In an example, the controller 150 is communicatively coupled to one or more sensors of the AC power supply 122. The controller 150 monitors and controls the functioning of the AC power supply 122.

In some embodiments, the controller 150 is communicatively coupled to the DC power supply 124. In an example, the controller 150 is communicatively coupled to one or more sensors of the DC power supply 124. The controller 150 monitors and controls the functioning of the DC power supply 124.

In some embodiments, the data center 100 or the local power distribution system 130 may include one or more communications network interfaces suitable for communicating information with other computers and electronic devices, including (for example) a central service, such as a cloud service, from which the data center 100 receives information including trained machine learning models and other data for use in autonomous control thereof. The one or more communications networks, for example, may include a wide area network (“WAN”) such as the Internet, one or more local area networks (“LANs”) such as Wi-Fi LANs, mesh networks, etc., or one or more bus subsystems. In some embodiments, the one or more communications networks utilize one or more standard communication technologies, protocols, and/or inter-process communication techniques. In some implementations, data collected by one or more sensors (such as described herein) can be uploaded to a remote data center, that may include a processor, via the one or more communications networks for additional processing.

The controller 150, as well as various additional controllers, processors, or subsystems such as disclosed herein, operates under the control of an operating system and executes or otherwise relies upon various computer software applications, components, programs, objects, modules, data structures, etc. Moreover, various applications, components, programs, objects. modules, etc. may also execute on one or more processors in another computer coupled to the data center 100 via the one or more communications networks, e.g., in a distributed, cloud-based, or client-server computing environment, whereby the processing required to implement the functions of a computer program may be allocated to multiple computers and/or services over a computer network.

In general, the routines executed to implement the various implementations described herein, whether implemented as part of an operating system or a specific application, component, program, object, module, or sequence of instructions, or even a subset thereof, may be referred to herein as “program code.” Program code typically includes one or more instructions that are resident at various times in various memory and storage devices, and that, when read and executed by one or more processors, perform actions necessary to execute operations embodying the various aspects of the present disclosure. Furthermore, while implementations are described herein in the context of fully functioning computers and systems, it will be appreciated that the various implementations described herein are capable of being distributed as a program product in a variety of forms, and that implementations can be implemented regardless of the particular type of computer readable media used to actually carry out the distribution.

In addition, one or more program codes described herein may be identified based upon the application within which a particular program code is implemented in a specific implementation. However, it should be appreciated that any particular program nomenclature herein is used merely for convenience, and thus the present disclosure should not be limited to use solely in any specific application identified and/or implied by such nomenclature. Furthermore, given the typically endless number of manners in which computer programs may be organized into routines, procedures, methods, modules, objects, or the like, as well as the various manners in which program functionality may be allocated among various software layers that are resident within a typical computer (e.g., operating systems, libraries, API's, applications, applets, etc.), it should be appreciated that the present disclosure is not limited to the specific organization and allocation of program functionality described herein.

The example environment illustrated is not intended to limit implementations disclosed herein. Indeed, other alternative hardware and/or software environments may be used without departing from the scope of implementations disclosed herein.

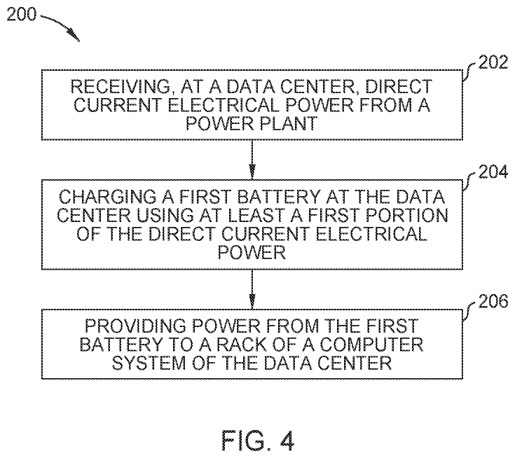

FIG. 4 is a flow diagram of a method 200 of operating a data center. In an example, the data center is data center 100. In some embodiments, method 200 is monitored by a controller, such as controller 150. In some embodiments, method 200 is controlled by a controller, such as controller 150. In some embodiments, various sensors are used in performing method 200. The sensors may include one or more voltmeters, ammeters, ohmmeters, or other such sensors, whether digital or analog. The sensors may be electrically coupled to the controller.

Operation 202 includes receiving, at the data center, direct current electrical power from a power plant (such as power plant 120). In some embodiments, the power plant includes one or more renewable energy sources, such as solar, solar thermal, wind, or geothermal energy sources. In some embodiments, the power plant includes a first renewable energy source and a different second renewable energy source. In some embodiments, the power plant produces direct current electrical power, and the direct current electrical power is transmitted to the charging station via a local power distribution system, such as local power distribution system 130. In some embodiments, the local power distribution system is operated as a DC microgrid.

Operation 204 includes charging a first battery at the data center using at least a first portion of the direct current electrical power. In some embodiments, operation 204 includes conveying the first portion of the direct current electrical power to the first battery via a direct current-to-direct current converter.

Operation 206 includes providing power from the first battery to a rack of a computer system of the data center. In some embodiments, the first battery is part of a computer system (such as computer system 110) that includes the rack (such as rack 112). In some embodiments, method 200 includes charging a second battery at the data center using at least a second portion of the direct current electrical power. In some embodiments, method 200 includes providing back-up power from the second battery to the first battery. In an example, the first battery is a local battery 114, and the second battery is a main battery 102.

In some embodiments, method 200 includes exporting data from the rack using power from at least one of the first battery or the second battery. In an example, exporting data from the rack includes using WIFI or routers of the rack. In another example, exporting data from the rack is performed using a metallic cable. In another example, exporting data from the rack is performed using a optical fiber cable. In another example, exporting data from the rack is performed via satellite. In another example, exporting data from the rack is performed via microwave.

It is contemplated that method 200 may include any one or more of the operations or activities described herein. It is contemplated that method 200 may be performed using at least some of the apparatus or systems described herein.

Aspects of the present disclosure include systems and methods for operating a data center. The systems and methods of the present disclosure may be established or performed in locations where there is no (or limited) existing electrical transportation infrastructure or capacity, such as in remote and/or rural areas.

It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

What is claimed is:

1. A system, comprising:
a power plant configured to produce direct current electrical power; and
a data center electrically coupled to the power plant, and configured to receive the direct current electrical power;
wherein the data center includes a first battery of a rack of a computer system, the first battery configured to receive a first portion of the direct current electrical power.

2. The system of claim 1, further comprising a local power distribution system configured to convey the direct current electrical power from the geothermal power plant to the data center.

3. The system of claim 2, wherein the local power distribution system is an autonomous power distribution system.

4. The system of claim 1, wherein at least a portion of the power plant is co-located with the data center.

5. The system of claim 1, further comprising a direct current-to-direct current converter electrically coupled to the power plant and the data center.

6. The system of claim 1, wherein the data center includes a second battery configured to receive a second portion of the direct current electrical power.

7. The system of claim 6, wherein the second battery is configured to provide back-up power to the first battery.

8. The system of claim 1, wherein the power plant includes one of a solar power plant, a solar thermal power plant, a wind-driven power plant, or a geothermal power plant.

9. The system of claim 8, wherein the power plant includes a different one of a solar power plant, a solar thermal power plant, a wind-driven power plant, or a geothermal power plant.

10. A system, comprising:
a power plant configured to produce direct current electrical power;
a data center electrically coupled to the power plant; and
a controller comprising instructions that, when executed, cause a plurality of operations to be conducted, the plurality of operations comprising:
receiving, at the data center, direct current electrical power from the power plant;
charging a first battery at the data center using at least a first portion of the direct current electrical power; and
providing power from the first battery to a rack of a computer system of the data center.

11. The system of claim 10, wherein the plurality of operations further comprise charging a second battery at the data center using at least a second portion of the direct current electrical power.

12. The system of claim 11, wherein the plurality of operations further comprise providing back-up power from the second battery to the first battery.

13. The system of claim 10, wherein the plurality of operations further comprise exporting data from the rack using a portion of the power from the first battery.

14. A method of operating a data center, comprising:
receiving, at the data center, direct current electrical power from a power plant;
charging a first battery at the data center using at least a first portion of the direct current electrical power; and
providing power from the first battery to a rack of a computer system of the data center.

15. The method of claim 14, wherein the first battery is part of a computer system that includes the rack.

16. The method of claim 15, further comprising charging a second battery at the data center using at least a second portion of the direct current electrical power.

17. The method of claim 16, further comprising providing back-up power from the second battery to the first battery.

18. The method of claim 17, further comprising exporting data from the rack using power from at least one of the first battery or the second battery.

19. The method of claim 14, wherein the power plant includes one of a solar power plant, a solar thermal power plant, a wind-driven power plant, or a geothermal power plant.

20. The method of claim 19, wherein the power plant includes a different one of a solar power plant, a solar thermal power plant, a wind-driven power plant, or a geothermal power plant.
